(19) United States
(12) Patent Application Publication
(10) Pub. No.: US 2024/0071003 A1
(43) Pub. Date: Feb. 29, 2024

(54) SYSTEM AND METHOD FOR IMMERSIVE TRAINING USING AUGMENTED REALITY USING DIGITAL TWINS AND SMART GLASSES

(71) Applicant: ThirdEye Gen, Inc, Princeton, NJ (US)

(72) Inventor: Nick Cherukuri, Princeton, NJ (US)

(73) Assignee: ThirdEye Gen, Inc, Princeton, NJ (US)

(21) Appl. No.: 17/899,683

(22) Filed: Aug. 31, 2022

(51) Int. Cl. G06T 19/00; G02B 27/01; G06F 3/04815; G09B 5/00

(52) U.S. Cl. CPC G06T 19/006; G02B 27/017; G06F 3/04815; G09B 5/00

(57) ABSTRACT

To provide an improved experience in generating and experiencing augmented reality training, a system and method may be provided. The process generally involves: selecting a digital twin of an apparatus or system to be used as part of a procedure for a trainee to be trained to perform; generating, on a first processor, an object-detection model based on the digital twin; receiving the digital twin at a second processor configured to provide a virtual reality (VR) authoring environment, and allowing a user to generate a training module based on the digital twin, the training module defining the procedure for the trainee to be trained to perform; and receiving, at a third processor, the object-detection model and the training module. Augmented Reality (AR) headsets and/or other AR-capable devices can then use the object-detection model and training module in order to provide an enhanced AR training experience.

### TECHNICAL FIELD

The present disclosure is drawn to the field of augmented reality, and specifically to the field of immersive training using augmented reality.

### BACKGROUND

Augmented and Virtual Reality both offer much promise for delivering immersive training. Together, these technologies allow the trainee to get guided hands-on experience with their tasks. Augmented Reality can take this training a step further by guiding the trainee through tasks on physical equipment and even following them into the real world to guide them step by step through actual maintenance procedures. And by adding in an adjustable learning management system, that training can even be tailored to each individual's aptitude and performance.

However, a major concern is that it is difficult and expensive to author immersive training. It often requires specialists in addition to the subject matter expert (SME), such as software developers and three-dimensional (3D) artists, which makes it challenging to develop and extremely painful to update or change. There is a clear need for automating this content generation.

### BRIEF SUMMARY

In some embodiments, a method for enabling augmented reality training is provided. The method may include: selecting a digital twin of an apparatus or system to be used as part of a procedure for a trainee to be trained to perform; generating, on a first processor, an object-detection model based on the digital twin; receiving the digital twin at a second processor configured to provide a virtual reality (VR) authoring environment, and allowing a user to generate a training module based on the digital twin, the training module defining the procedure for the trainee to be trained to perform; and receiving, at a third processor, the object-detection model and the training module.

In some embodiments, the method may include automatically adding the training module to a trainee task list. In some embodiments, the method may include sending, to an augmented reality (AR) headset, the object-detection model and the training module. In some embodiments, the method may include detecting, by the AR headset, a presence of an apparatus or system based on the object-detection model.

In some embodiments, the first processor may be configured to allow an object-detection model to be generated by either: (1) creating a model target from the digital twin; and/or automatically training a machine learning algorithm by: (i) automatically generating a training dataset, the training dataset including a plurality of images based on the digital twin, the plurality of images each being automatically created using different settings; and (ii) training the machine learning algorithm using the training dataset.

In some embodiments, the VR authoring environment may be configured to allow a user to virtually select a tool from a toolbox. In some embodiments, the VR authoring environment may be configured to allow a user to add audio annotations to describe what a trainee should do during a step in the procedure for the trainee to be trained to perform. In some embodiments, the VR authoring environment may be configured to allow a user to add images to be displayed during the procedure for the trainee to be trained to perform. In some embodiments, the VR authoring environment may be configured to allow a user to review and/or edit a training module before completing the module and sending it to the third processor.

In some embodiments, a system for enabling augmented reality training is provided. The system may include a first processor configured to receive a digital twin and generate an object-detection model based on the digital twin; a second processor configured to receive the digital twin and provide a virtual reality (VR) authoring environment configured to generate a training module using the digital twin; a third processor configured to receive the object-detection model and the training module, and add the training module to a task list of a plurality of trainees; and a plurality of augmented reality (AR) headsets, each AR headset configured to receive the training module and the object-detection model after the training modules are added to a task list associated with a user of the AR headset, each user being one trainee of the plurality of trainees.

In some embodiments, the first processor may be configured to automatically generate an object-detection model by: automatically generating a training dataset, the training dataset including a plurality of images based on the digital twin, the plurality of images each being automatically created using different settings; and training a machine learning algorithm using the training dataset, machine learning algorithm defining the object-detection model.

In some embodiments, each AR headset is configured to detect a presence of an apparatus or system based on the object-detection model.

In some embodiments, the VR authoring environment may be configured to allow a user to virtually select a tool from a toolbox. In some embodiments, the VR authoring environment may be configured to allow a user to add audio annotations to describe what a trainee should do during a step in the procedure for the trainee to be trained to perform. In some embodiments, the VR authoring environment may be configured to allow a user to add images to be displayed during the procedure for the trainee to be trained to perform. In some embodiments, the VR authoring environment may be configured to allow a user to review and/or edit a training module before completing the module and sending it to the third processor.

In some embodiments, a remote expert, who could be in front of a computer, may author content by annotating virtually onto the smart glasses or digital twin screen the virtual instructions, which can include, e.g., virtual arrows and/or shapes. The remote expert may also upload their voice and 3D model using, e.g., a LiDAR sensor on the smart glasses and enable remote 3D telepresence for the field technician while simultaneously displaying the digital twin model. This virtual expert and training are all saved in the cloud database storage and locked via mobile device management system with end-to-end encryption. This virtual avatar and training information can be downloaded and displayed again on the smart glasses anytime via, e.g., cloud storage. The virtual avatar is adjusted for low latency using frame buffering on a processor chip on the trainee's smart glasses.

### BRIEF DESCRIPTION OF THE DRAWINGS

FIG. 1 is a block diagram of a generalized system.

FIG. 2 is a flowchart of a method.

FIG. 3 is an illustration of an example of a portion of a trainee view of a training module.

FIG. 4 is a flowchart of a method for generating an object-detection model.

FIGS. 5A and 5B are illustrations of a VR authoring environment.

FIG. 6A is a block diagram of various components and their connections of an AR headset.

FIG. 6B is an illustration of a front perspective view of an AR headset.

FIG. 7 is a block diagram of a system for utilizing a remote expert to assist a trainee.

### DETAILED DESCRIPTION

As used herein, the term “digital twin” refers to a virtual representation that serves as the real-time digital counterpart of a physical object or process. This is preferably a virtual representation generated via, e.g., three-dimensional computer-aided design (CAD) software. However, those of skill in the art will recognize that other techniques for generating digital twins can be utilized.

Disclosed is a system and method that provide a solution in three parts. The system and method can be used to enable and improve augmented reality training, making content generation for AR training easier to generate.

First, a digital twin is used to create a machine learning (ML) model to detect the actual equipment and get its orientation (pose) in the world. Next, a virtual reality authoring environment is created around the digital twin. Finally, an AR maintenance training application is delivered that lets a trainee train on real-world equipment with virtual lessons and guidance.

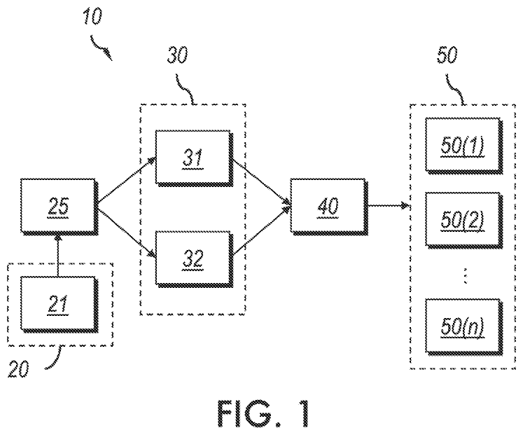

Referring to FIG. 1, this approach can be seen graphically. Specifically, in the system 10, a digital twin 21, which may be stored on a non-transitory computer readable storage medium 20 operably coupled to a processor 25, is provided as input to a two-pronged process 30 that includes an automatic pipeline 31 to generate a 3D object detection model, as well as a virtual reality (VR) authoring environment 32 of the SME. The SME then authors content in VR. When done creating, the SME publishes the training to a learning platform 40, such as Moodle, where trainees can download it to their devices 50 (such as first device 50(1), second device 50(2), and n-th device 50(n)).

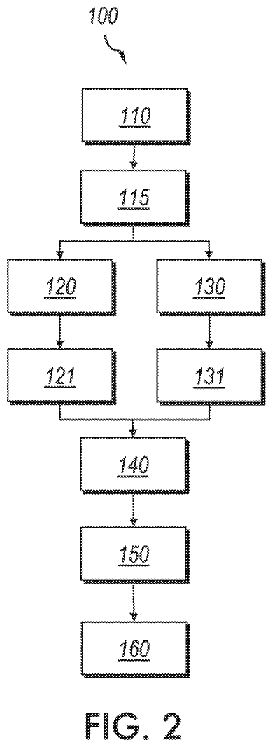

In some embodiments, a method for augmented reality content generation is provided. Referring to FIG. 2, the method 100 may include generating 110 a digital twin. As disclosed herein, these virtual representations may be generated using three-dimensional computer-aided design (CAD) software. These digital twins may also be generated, e.g., by applying photogrammetry software to captured images of a real-world object. Other appropriate techniques may be used; creating such digital twins is well known in the art.

For content authoring, imagine that an SME with no programming skills wants to make a training program for new recruits on how to check and replace an air filter in a vehicle.

Such an individual can grab a VR headset (such as an Oculus Quest), and, using an application or web browser, finds a digital twin (which was previously generated) they want to use, and selecting it. That is, in some embodiments, the method may include selecting a digital twin of an apparatus or system to be used as part of a procedure for a trainee to be trained to perform.

The system receives 115 the selection, and a two-prong approach begins. For example, a background task of generating the object detection models may be created, and the SME or user may then receive a link to download a VR authoring application and/or the application with the digital twin already instantiated may be opened.

Thus, the method may include receiving 120 the digital twin at a first processor, and generating 121 an object-detection model based on the digital twin.

In some embodiments, the generation of an object-detection model may include creating a model target from the digital twin. This process of creating the model target may include identifying physical dimensions of the model target, identifying one or more color of one or more parts of the model target, simplifying the model target by reducing a number of vertices or parts, and/or identifying whether the model target is expected to be in motion or not.

These model targets can then be compared to the images being received from a camera on an AR headset. As used herein, “AR headset” may refer to not only dedicated AR headsets, but also any AR-capable device (such as a smartphone) that is configured to use the object-detection model and training module as disclosed herein in order to provide an enhanced AR training experience for a user.

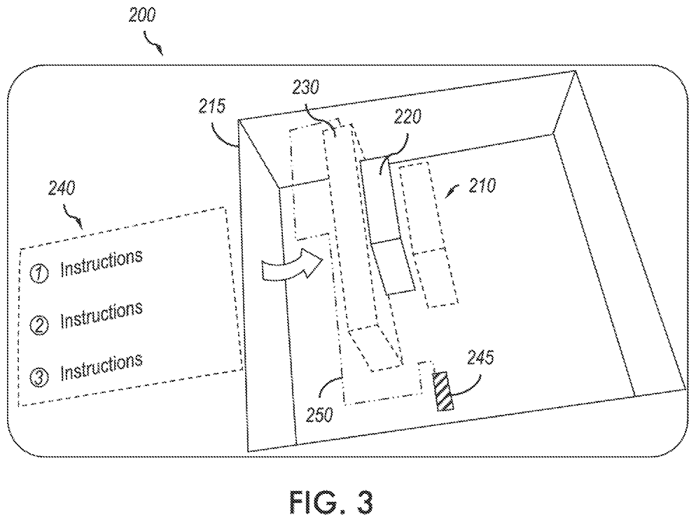

An example of this can be seen in FIG. 3, showing an image 200 as seen by a user of an AR headset, where the image contains a real-world breaker box 215 containing a plurality of real-world breakers 220, 230.

A first real-world breaker 230 is on the left. The method may include having the AR headset detect the presence of an apparatus or system based on the object detection model. That is, this breaker may be detected as existing in the field of view of the AR headset, the position of the breaker may be determined, and the edges of the breaker may be detected. In some embodiments, the breaker may be, e.g., highlighted in a color (such as green) after a trainee touches it, if the image received matches a model target (or, as discussed later, if a trained ML algorithm determines it matches).

Wiring instructions 240 for that breaker may be shown, e.g., to the left of the breaker. Such instructions may be included, e.g., on a database the headset is connected to, and may include details for how to install a connector 245 to the breaker, where a wiring path 250 may be shown virtually. In some embodiments, the virtual wiring may be dynamically occluded by real-world physical components (e.g., depending on the viewing angle, in some embodiments, the wiring path shown may be occluded by, e.g., the real-world breaker box 215, breakers installed in the box, etc.).

In the image 200, the virtual breakers 210 may be present, that match the model target. In some embodiments, a user's hand positions are tracked, and the user may interact with a virtual breaker. In some embodiments, instructions may be provided and used to train the trainee by guiding the trainee on how to insert the virtual breaker into the breaker box. After installing the virtual breaker, the virtual breaker may then be treated similar to the first real-world breaker 230, where a user can touch the installed virtual breaker to bring up instructions for additional connections, etc. The user may use, e.g., an AR headset or phone to see the images and training.

In some embodiments, recorded voice instructions and real-world AR holograms guide them through each step.

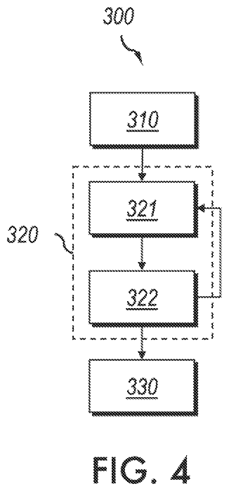

In some embodiments, the generation of an object-detection model may include training a machine learning algorithm. Referring to FIG. 4, in some embodiments, this method 300 may include incorporating 310 the received digital twin into a virtual environment. A repetitive process 320 is then utilized to generate a large library (i.e., a training dataset) of annotated images based on the digital twin, each image generated using different settings. This process includes adjusting 321 settings of the virtual environment, generating 322 an annotated image based on those settings, and repeating. Typically, this large library includes at least 1,000 different images, may include at least 10,000 different images, and may include 50,000 different images or more. The settings being adjusted include backgrounds, camera parameters, positions, materials, and lighting conditions.

These annotated images in the large library are then used as a training dataset to train 330 a machine learning algorithm (such as a TensorFlow model) that can recognize the equipment's pose. Thus, the method may include training a machine learning algorithm using the training dataset, where the machine learning algorithm defines the object-detection model.

While the generation of the object-detection model(s) may be performed on a remote processor (such as a cloud-based server, etc.), once the models have been created, such models may be run entirely contained on an AR headset or phone with no additional network connection required.

Referring to FIG. 2, the method may include receiving 130 the digital twin at a second processor (e.g., the processor configured to provide the VR authoring environment of a SME). The SME may then author and submit new content.

That is, the method may include receiving the digital twin at a second processor configured to provide a virtual reality (VR) authoring environment, and then allowing a user to generate a training module based on the digital twin. The training module will define the procedure for the trainee to be trained to perform.

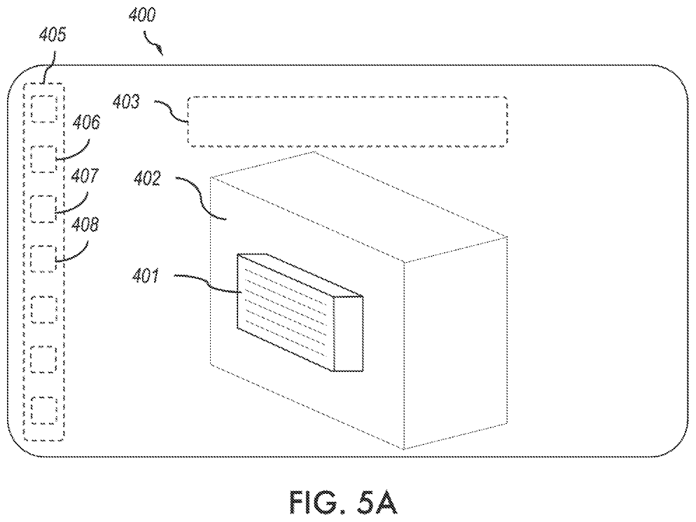

The VR authoring environment may include several authoring tools. In some embodiments, having received the digital twin, the VR authoring environment may first be configured to display, e.g., a button that the SME may be able to select/touch to start step one of the authoring process. Referring to FIG. 5A, in some embodiments, the VR authoring environment may then be configured to display a user interface that includes, e.g., a view of the In this air filter example, the SME would touch the air filter 401 on the digital twin 402 (e.g., a digital twin of some device the filter is connected to), and the application could be configured to highlight it. The VR authoring environment may be configured to provide a text entry field 403, where the SME could then enter, e.g., “locate the air filter” as the title.

These user interfaces may include, e.g., icons 405 representing authoring tools, such as a move tool 406, an audio annotation tool 407, and a virtual toolbox tool 408.

After entering the title, the SME could begin the next step. Referring to FIG. 5B, in this example, the SME could grab a virtual box wrench 411 from a side toolbar 412. Side toolbar 412 may be shown, e.g., when selecting the virtual toolbox tool 408. The SME may make a hand motion to use it on the virtual filter, which is captured by the VR authoring environment.

In some embodiments, the second processor is configured to allow a user to add audio annotations to describe what a trainee should do during a step in the procedure for the training to be trained to perform. The SME could select, e.g., audio annotation tool 407 to record a voice instruction and tell a trainee to use a ¼″ box wrench in a counterclockwise motion to loosen the air filter bolt.

The SME could then remove the air filter by selecting the move tool 406 and grabbing it with their hand in VR. The SME could then hold it up and record instructions for inspecting it. In some embodiments, the VR authoring environment could be configured to allow the SME to add images, such as an image of a dirty or damaged filter, at this time, or at a later point in time.

The SME could then grab a virtual compressed air hose (not shown), and show how to clean it before reinstalling before creating a final set of steps depicting the reinstall process.

As the last step, they could provide a link to the official training manual for reference. In some embodiments, the VR authoring environment is configured to ask the SME if they wish to link to an official training manual. In some embodiments, the VR authoring environment may use metadata from the digital twin to automatically search and link the official training manual from a source (such as a database or website) of such manuals. For example, if the metadata of the digital twin indicates the digital twin is of model number X from company Y, the VR authoring environment may be configured to automatically search company Y's website of product manuals for model number X, and automatically link to that manual if found.

While the SME is creating, the VR authoring environment is configured to record their hand motions, all interactions with the digital twin, and any voice notes they make. The VR authoring environment is configured to allow the SME to, after they are finished, play it back and edit sections.

In some embodiments, the SME can also adjust and identify metrics. For example, in step one, they could require the trainee to touch the air filter, or they could choose that time to completion is less critical than not missing any steps. The SME will even be able to run through the training as the trainee and record their time and metrics as a baseline for the system to compare new trainees to.

Once the SME is satisfied, they can click publish to a learning platform as a training module.

Referring to FIG. 2, that is, the object-detection model and the training module will be sent to a third processor running a learning platform, and the learning platform will receive 140 the object-detection model and the training module. In some embodiments, the first processor may be configured to send the object-detection model to the third processor, and the second processor may be configured to send the training module to the third processor. In some embodiments, the first processor may be configured to send the object-detection model to the second processor, and the second processor may be configured to send the training module and the object-detection model to the third processor.

In some embodiments, the SME's finalizing the training module will send the completed training file to the learning platform (e.g., Moodle, etc.) through an application programming interface (API).

In some embodiments, the method includes adding 150, by the learning platform, each received training module to one or more trainees' task lists.

In some embodiments, each AR headset associated with the one or more trainees is configured to receive 160 the training module and object detection model from the learning platform, after which time the user may complete the training module using an AR headset or smart phone.

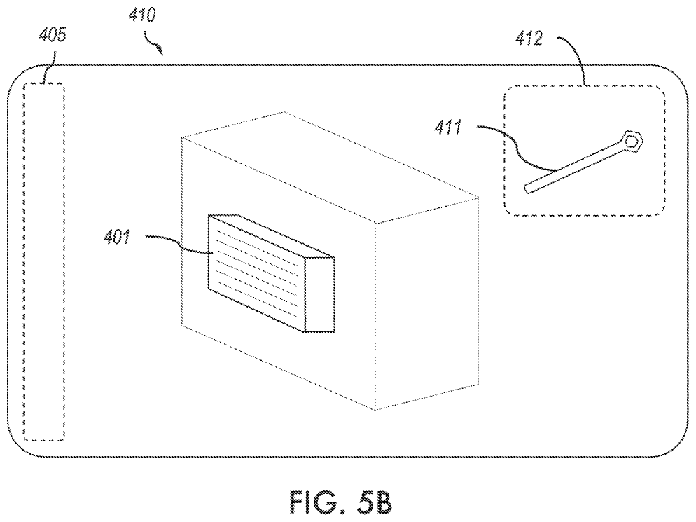

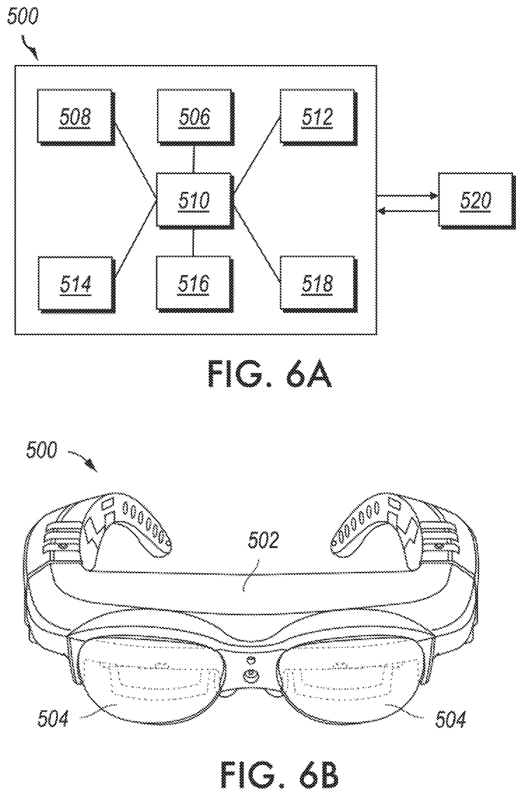

A non-limiting example of an AR headset can be seen with reference to FIGS. 6A and 6B. Referring to FIGS. 6A and 6B, the AR headset or AR glasses may include a frame 502 supporting a glasses lens/optical display 504, which is configured to be worn by the user. The frame 502 is associated with a processor. In some embodiments, AR headset or AR glasses may include a processor 510, such as a qualcomm xr1 or xr2 processor which contains, e.g., 4 GB RAM, 64 GB storage, an integrated cpu/gpu and an additional memory option via usb-c port. The processor may be located on, e.g., the left-hand side arm enclosing of the frame and shielded with protective material to dissipate the processor heat. Generally, the processor 510 may be configured to synchronize data (such as the IMU data) with camera feed data, to provide a seamless display of 3D content of the augmented reality application 520. The glasses lens/optical display 504 may be coupled to the processor 510 and a camera PCB board. In some embodiments, an IMU and/or UWB tag may be present in or on any portion of the frame. For example, in some embodiments, the IMU and UWB tag are positioned above the glasses lens/optical display 504.

A sensor assembly 506 may be in communication with the processor 510.

A camera assembly 508 may be in communication with the processor and may include, e.g., a 13-megapixel RGB camera, 2 wide angle grey scale cameras, a flashlight, an ambient light sensor (ALS) and a thermal sensor. All these camera sensors may be located on the front face of the headset or glasses and may be angled, e.g., 5 degrees below horizontal to closely match the natural human field of view.

A user interface control assembly 512 may be in communication with the processor 510. The user interface control assembly may include, e.g., audio command control, head motion control and a wireless Bluetooth controller which may be coupled to, e.g., an android wireless keypad controlled via a built-in Bluetooth BT 5.0 LE system in the xr1 processor. The head motion control may utilize a built-in android IMU sensor to track the user's head movement via three degrees of freedom, i.e., if a user moves their head to the left the cursor moves to the left as well. The audio commands may be controlled by, e.g., a three-microphone system located in the front of the glasses that captures audio commands in English. These different modes of UI allow the user to pick and choose their personal preference for UI.

In some embodiments, the single device may include a radio in communication with the processor 510, the radio having a range of 3-10 miles line-of-sight, and a bandwidth less than 30 kbits/sec. In some embodiments, the radio is a Long Range (LoRa) radio.

A fan assembly 514 may be in communication with the processor 510, wherein the fan assembly 514 is synchronized to speed up or slow down based on the processor's heat.

A speaker system or speaker 516 may be in communication with the processor 510. The speaker system or speaker may be configured to deliver audio data to the user via the communication unit

A connector port assembly 518 may be in communication with the processor. The connector port assembly may have, e.g., a mini-jack port and a Universal Serial Bus Type-C (USB-C) port. The connector port assembly 518 allows users to insert their manual audio headphones. The USB-C port allows the user to charge the device or data-transfer purposes. In one embodiment, the frame 502 is further integrated with a wireless transceiver coupled to the processor 510.

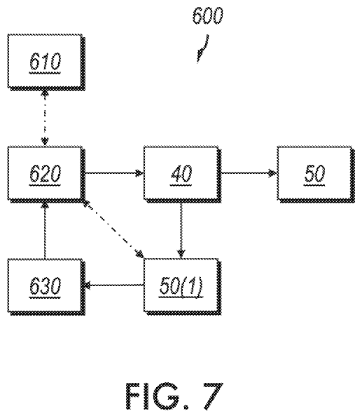

In some embodiments, a remote expert (who could be in front of a computer, on a phone, in a recording studio, etc.) authors by annotating virtually onto the smart glasses or digital twin screen the virtual instructions. These annotations may include, e.g., virtual arrows and/or shapes. Referring to FIG. 7, the system 600 may have a remote expert 610 that interacts with an authoring environment 620 (which may be, e.g., a VR authoring environment). In some embodiments, in the authoring environment, the remote expert can, e.g., upload their voice and narrate or talk a trainee using a first device 50(1) through a particular process. For example, in some embodiments, data from a camera in the first device is sent to a processor, such as the processor used to generate the authoring environment, to allow the expert to see what the user is viewing. The camera may send images or video.

In some embodiments, a LiDAR sensor on the first device 50(1) (such as smart glasses) can capture data about the environment. In some embodiments, the camera data and/or the LiDAR data are used to generate a digital twin and/or a 3D model of the environment the trainee is experiencing.

This data may be sent to, e.g., a processor 630 for generating such models or twins prior to being sent to the authoring environment. In some embodiments, the expert may then use the digital twin and/or 3D model of the environment to develop a training module as disclosed herein, which can then be sent to a training platform and downloaded by the trainee's system. In some embodiments, the authoring environment is configured to allow the expert to annotate or describe what the trainee should do in real-time, allowing the expert to provide remote 3D telepresence.

In some embodiments, the authoring environment is configured to allow the expert to manipulate the digital twin and annotate and/or provide voice instructions, and the manipulations, annotations, and voice instructions are sent to the trainee on the first device 50(1). This may be done in addition to a training module being created and uploaded to the training platform. This “virtual expert” and training is then saved in a database (such as cloud database storage). In some embodiments, this may include locking the content via mobile device management system with end-to-end encryption. In some embodiments, this virtual avatar and training information can be downloaded and displayed again on any of the devices 50 at any time. The virtual avatar may be adjusted for low latency using frame buffering on the processor (e.g., processor 210) on the AR headset (such as smart glasses).

As will be understood by those of skill in the art, each processor as described herein may be coupled to a non-transitory computer readable medium containing instructions that, when executed by the processor, configured the processor in the manner disclosed herein. Each processor may be coupled to a memory.

As used herein, the term “processor” may refer to, is part of, or includes circuitry capable of sequentially and automatically carrying out a sequence of arithmetic or logical operations; recording, storing, and/or transferring digital data. The term “processor” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. A processor may comprise circuitry. As used herein, the term “circuitry” refers to, is part of, or includes hardware components such as an electronic circuit, a logic circuit, and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

What is claimed is:

1. A method for enabling augmented reality training, comprising:
selecting a digital twin of an apparatus or system to be used as part of a procedure for a trainee to be trained to perform;
generating, on a first processor, an object-detection model based on the digital twin;
receiving the digital twin at a second processor configured to provide a virtual reality (VR) authoring environment, and allowing a user to generate a training module based on the digital twin, the training module defining the procedure for the trainee to be trained to perform; and
receiving, at a third processor, the object-detection model and the training module.

2. The method according to claim 1, further comprising automatically adding the training module to a trainee task list.

3. The method according to claim 2, further comprising sending, to an augmented reality (AR) headset, the object-detection model and the training module.

4. The method according to claim 3, further comprising detecting, by the AR headset, a presence of an apparatus or system based on the object-detection model.

5. The method according to claim 4, wherein the first processor is configured to allow an object-detection model to be generated by either:
creating a model target from the digital twin; or
automatically training a machine learning algorithm by:
automatically generating a training dataset, the training dataset including a plurality of images based on the digital twin, the plurality of images each being automatically created using different settings; and
training the machine learning algorithm using the training dataset.

6. The method according to claim 5, wherein the VR authoring environment is configured to allow a user to virtually select a tool from a toolbox.

7. The method according to claim 6, wherein the VR authoring environment is configured to allow a user to add audio annotations to describe what a trainee should do during a step in the procedure for the trainee to be trained to perform.

8. The method according to claim 7, wherein the VR authoring environment is configured to allow a user to add images to be displayed during the procedure for the trainee to be trained to perform.

9. The method according to claim 8, wherein the VR authoring environment is configured to allow a user to edit a training module before completing the module and sending it to the third processor.

10. A system for enabling augmented reality training, comprising:
a first processor configured to receive a digital twin and generate an object-detection model based on the digital twin;
a second processor configured to receive the digital twin and provide a virtual reality (VR) authoring environment configured to generate a training module using the digital twin;
a third processor configured to receive the object-detection model and the training module, and add the training module to a task list of a plurality of trainees; and
a plurality of augmented reality (AR) headsets, each AR headset configured to receive the training module and the object-detection model after the training modules are added to a task list associated with a user of the AR headset, each user being one trainee of the plurality of trainees.

11. The system according to claim 10, wherein the first processor is configured to automatically generate an object-detection model:
automatically generating a training dataset, the training dataset including a plurality of images based on the digital twin, the plurality of images each being automatically created using different settings; and
training a machine learning algorithm using the training dataset, machine learning algorithm defining the object-detection model.

12. The system according to claim 11, wherein the plurality of AR headsets are each configured to detect a presence of an apparatus or system based on the object-detection model.

13. The system according to claim 12, wherein the VR authoring environment is configured to allow a user to virtually select a tool from a toolbox.

14. The system according to claim 13, wherein the VR authoring environment is configured to allow a user to add audio annotations to describe what a trainee should do during a step in the procedure for the trainee to be trained to perform.

15. The system according to claim 14, wherein the VR authoring environment is configured to allow a user to add images to be displayed during the procedure for the trainee to be trained to perform.

16. The system according to claim 15, wherein the VR authoring environment is configured to allow a user to review and edit a training module before completing the module and sending it to the third processor.

17. The system according to claim 16, wherein the system is further configured to:
generate a digital twin based on data received from a first AR headset of the plurality of AR headsets;
receive input from a user describing a step that must be performed; and
sending the digital twin and the input to the first AR headset.

18. The system according to claim 17, wherein the system is further configured to save the digital twin and the received input in a remote database and allow the digital twin and received input to be accessed by the plurality of AR headsets.
